(19) United States
(12) Patent Application Publication
(10) Pub. No.: US 2002/0045034 A1
(43) Pub. Date: Apr. 18, 2002

(54) Ink-jet recording material

(76) Inventors: Hanae Nakatani, Tokyo (JP); Makoto Yoshimura, Tokyo (JP); Ikumi Sudo, Tokyo (JP)

Correspondence Address: MANELLI DENISON & SELTER, 2000 M STREET NW SUITE 700, WASHINGTON, DC, 20036-3307, US

(21) Appl. No.: 09/933,668

(22) Filed: Aug. 22, 2001

(30) Foreign Application Priority Data
Aug. 23, 2000 (JP) 252650/2000

(51) Int. Cl. B32B 3/00

(52) U.S. Cl. 428/195

(57) ABSTRACT

There is disclosed an ink-jet recording material comprising a support in which both surfaces of a base paper are covered by a polyolefin resin, and an ink-receptive layer containing inorganic fine particles and a hydrophilic binder provided on the support, wherein the ink-jet recording material satisfies a relation of {(B+C)/A}=0.15 to 0.45, where A is a thickness of the base paper; B is a thickness of the polyolefin resin layer at the surface on which the ink-receptive layer is provided; and C is a thickness of the polyolefin resin layer at the opposite surface to that on which the ink-receptive layer is provided, a density of the base paper is 0.60 to 1.05 g/cm³, A is 50 to 300 μm, and B is 5 to 25 μm.

### BACKGROUND OF THE INVENTION

1. Field of the Invention

This invention relates to an ink-jet recording material having an ink-receptive layer, more specifically to an ink-jet recording material particularly excellent in high glossiness and ink-absorption property, which is less likely to have flaws and uneven glossiness on the surface of an ink-receptive layer when it is kept in a rolled state during a heating process following production or during storage after processing.

2. Prior Art

As a recording material to be used for an ink-jet recording system, there has generally been known a recording material which comprises a swelling type ink-receptive layer comprising a binder that is swelled by a solvent such as water, etc. or a porous ink-receptive layer comprising a pigment such as amorphous silica, etc. and a water-soluble binder such as polyvinyl alcohol, etc., being provided on a support such as a usual paper or the so-called ink-jet recording sheet. In terms of ink-absorption property, the one with a porous ink-receptive layer is more preferred.

There have been proposed recording materials obtained by coating a silicon-containing pigment such as silica, etc., with an aqueous binder onto a paper support as disclosed in, for example, Japanese Provisional Patent Publications No. 51583/1980, No. 157/1981, No. 107879/1982, No. 107880/1982, No. 230787/1984, No. 160277/1987, No. 184879/1987, No. 183382/1987, No. 11877/1989, and the like.

Also, in Japanese Patent Publication No. 56552/1991, Japanese Provisional Patent Publications No. 188287/1990, No. 81064/1998, No. 119423/1998, No. 175365/1998, No. 203006/1998, No. 217601/1998, No. 20300/1999, No. 20306/1999 and No. 34481/1999, U.S. Pat. No. 5,612,281, and EP 0 813 978 A, and the like, there have been disclosed ink-jet recording materials using synthetic silica fine particles prepared by a gas phase process (hereinafter referred to as “fumed silica”). The fumed silica is ultrafine particles having a mean particle size of a primary particle of several nm to several tens nm, and has characteristics of giving high glossiness and high ink-absorption properties. However, since it is ultrafine particles, there is a problem that the surface of the ink-receptive layer tends to have flaws and uneven glossiness when the product is subjected to a heat treatment or preserved in a rolled state.

On the other hand, as a support for the ink-jet recording material, paper has generally been used, where the paper itself has a roll of an ink-receptive layer. In recent years, a photo-like recording sheet has earnestly been desired. However, a recording sheet using paper as a support has problems in glossiness, the feel of a material, water resistance, cockling (wrinkle or surface waviness) after printing, and the like. Thus, a water resistant paper support, for example, a resin-laminated paper (polyolefin resin-coated paper) in which a polyolefin resin such as polyethylene is laminated on the both surfaces of paper has now been used. However, different from a paper support, these polyolefin resin-coated papers have highly smooth surface where the ink-receptive layer is provided, thereby increasing a chance of causing flaws and uneven glossiness on the surface of the ink-receptive layer when kept in a rolled state at the time of a heat treatment during production or during storage after processing. In particular, since the support itself does not have an ink-absorption property, an ink-receptive layer is provided thick. Therefore, its surface shows more smoothness and glossiness, resulting in an even higher chance of flaws or uneven glossiness that is troublesome.

In addition, there is an increasing demand for speeding up the printing speed of the ink-jet printing. And in order to attain higher ink-absorption property, it is necessary to keep a content of the binder in the receptive layer small, relative to inorganic fine particles. However, by setting this ratio smaller, the flaws on the ink-receptive layer are more likely to occur during storage.

In general, the ink-jet recording material is kept in a rolled state during a heating process of production or during storage. And in case of an ink-jet recording material with a particularly high glossiness and smoothness, there has been a problem that flaws or uneven glossiness is caused on the ink-receptive layer when it is kept in a rolled state after processing or storage. The cause is unknown, but it is expected that in a rolled state where the recording material is wound up while applying tensile force, the front and the back surface of the recording material are attached each other, and a convex portion of the back surface is pushed into the ink-receptive layer of the front surface, where in course of time, this differential expansion causes flaws. Particularly when a support has uneven roughness so-called twist or swell, the flaws and uneven glossiness are markedly caused.

### SUMMARY OF THE INVENTION

Accordingly, an object of the present invention is to provide an ink-jet recording material comprising, a polyolefin resin-coated paper, and provided thereon, an ink-receptive layer whose glossiness and ink-absorption capacity are improved to a high level by using inorganic fine particles, especially fumed silica, and causing less flaws and uneven glossiness on the surface of the ink-receptive layer when it is kept in a rolled state.

The above-mentioned objects of the present invention can be accomplished by the following means.

(1) An ink-jet recording material comprising a support in which both surfaces of a base paper are covered by a polyolefin resin, and an ink-receptive layer containing inorganic fine particles and a hydrophilic binder provided on the support, wherein the ink-jet recording material satisfies a relation of {(B+C)/A)}=0.15 to 0.45, where A is a thickness of the base paper; B is a thickness of the polyolefin resin layer at the surface on which the ink-receptive layer is provided; and C is a thickness of the polyolefin resin layer at the opposite surface to that on which the ink-receptive layer is provided, a density of the base paper is 0.60 to 1.05 g/cm³, A is 50 to 300 μm, and B is 5 to 25 μm.

(2) The ink-jet recording material described in (1), wherein a ratio of B/C is less than 1.

(3) The ink-jet recording materials described in (1) and (2), wherein B is 8 μm or more and less than 20 μm.

(4) The ink-jet recording material described in (1), wherein the ink-receptive layer contains the inorganic fine particles in an amount of 50 to 90% by weight.

(5) The ink-jet recording material described in (1), wherein the inorganic fine particles are fumed silica which has an average particle size of primary particles of 5 to 50 nm.

(6) The ink-jet recording material described in (1), wherein the ink-receptive layer contains an amphoteric surfactant.

(7) The ink-jet recording material described in (6), wherein the ink-receptive layer contains the amphoteric surfactant in an amount of 0.1 to 5% by weight.

(8) The ink-jet recording material described in (1), wherein the ink-receptive layer contains the hydrophilic binder in an amount of 10 to 25% by weight.

### DESCRIPTION OF THE PREFERRED EMBODIMENTS

In the following, the embodiments of the present invention are explained in detail.

A polyolefin resin-coated paper support (hereinafter referred to as “a resin-coated paper”) to be used in the present invention is explained in detail. In the resin-coated paper to be used in the present invention, its water content is not particularly limited, and preferably, in terms of curling property, in the range of 5.0 to 9.0% by weight, more preferably in the range of 6.0 to 9.0% by weight based on the total weight of the resin-coated paper.

A base paper constituting the resin-coated paper to be preferably used in the present invention is not particularly limited, and any paper generally used may be employed. More preferably a smooth base paper such as that used for a photographic support may be used. As pulp for constituting the base paper, natural pulp, regenerated pulp, synthetic pulp, etc. may be used singly or in combination of two or more. In the base paper, various additives conventionally used in the paper-manufacturing industry such as a sizing agent, a strengthening additive of paper, a loading material, an antistatic agent, a fluorescent brightener, a dye, etc. may be formulated.

Moreover, a surface sizing agent, a surface strengthening additive of paper, a fluorescent brightener, an antistatic agent, a dye, an anchoring agent, etc. may be coated on the surface of the paper.

A thickness of the base paper is 50 μm or more in the present invention. If it is thinner than 50 μm, its cushioning property is lowered, and distortion becomes small when force is applied on the ink-receptive layer, causing more flaws when kept in a rolled state. Though there is no upper limit, it is preferably 300 μm or less. If it is thicker than 300 μm, it causes inconvenience in handling of the recording material, and increases a production cost per unit area. It is preferred that the base paper is surface-treated by compression under pressure using a calender, etc. during or after production, in order to give a smoothness on the surface. When a density of the base paper is larger than 1.05 g/m³, its cushioning property and its supporting strength are impaired, therefore, flaws or poor conveying property tends to become a problem. On the other hand, when the density of the base paper is too low, the surface smoothness is lowered, so the lower limit is 0.60 g/m³ or more, preferably 0.70 g/m³ or more.

As a polyolefin resin for coating the base paper, examples may include a homopolymer of an olefin such as low density polyethylene, high density polyethylene, polypropylene, polybutene, polypentene, etc.; a copolymer comprising two or more olefins such as an ethylene-propylene copolymer, etc, and these polymers having various densities and melt viscosity indexes (melt index) may be used singly or in combination thereof.

Also, to the resin of the resin-coated paper, various kinds of additives including a white pigment such as titanium oxide, zinc oxide, talc, calcium carbonate, etc.; an aliphatic amide such as stearic amide, arachidamide, etc.; an aliphatic acid metal salt such as zinc stearate, calcium stearate, aluminum stearate, magnesium stearate, etc.; an antioxidant such as Irganox 1010, Irganox 1076 (both trade names, available from Ciba Geigy AG), etc.; a blue-color pigment or dye such as cobalt blue, ultramarine blue, cecilian blue, phthalocyanine blue, etc,; a magenta-color pigment or dye such as cobalt violet, fast violet, manganese violet, etc.; a fluorescent brightener, an UV absorber, etc. may be preferably added optionally combining two or more.

The resin-coated paper can be prepared by casting a melted resin under heating on a running base paper, which is so-called the extrusion coating method, and the both surfaces of the base paper are generally coated by the resin. Prior to coating the resin on the base paper, it is preferable to carry out on the base paper an activation treatment such as a corona discharge treatment, a flame treatment, etc. For the purpose of preventing curling, coating of the resin is generally carried out also at the back surface. The back surface is usually a non-gloss surface, and if necessary, the activation treatment such as the corona discharge treatment, the flame treatment, etc. may be applied to the both front and back surfaces.

In the present invention, a thickness B of the polyolefin resin (hereinafter referred to as “a front surface resin”) layer at the surface on which the ink-receptive layer is provided is 5 to 25 μm. If B is thicker than 25 μm, it is more likely to cause flaws on the ink-receptive layer probably due to a lowered cushioning property. If B is thinner than 5 μm, the surface of the ink-receptive layer looses gloss and smoothness. It is preferably in the range of 8 μm or more, and less than 20 μm. A thickness C of the polyolefin resin (hereinafter referred to as “a back surface resin”) layer at the opposite surface to that on which the ink-receptive layer is provided is basically determined appropriately in view of a thickness and a surface property of the base paper and a curling property of the support. In the present invention, C is determined so that a ratio represented by B/C becomes preferably less than 1. When B/C is less than 1, not only it prevents a plus curl which forms concavo shape on the coated surface when the ink-receptive layer is coated on the support, but also the front surface resin becomes relatively thinner, increasing a cushioning property on the ink-receptive layer side, whereby it reduces a possibility to cause flaws on the ink-receptive layer when stored in a rolled state.

The front surface resin layer of the resin-coated paper of the present invention can be prepared by heating and melting a polyolefin resin mainly on one surface of a base paper by an extruder, extruding the material between the base paper and cooling roll in a film state, adhering by pressure and cooling. At this time, the cooling roll is used for formation of a front surface shape of the coating layer made of the polyolefin resin. The surface of the resin layer can be subjected to embossing treatment such as a mirror surface, slightly rough surface, or patterned surface such as silk state or matte state, etc. depending on the shape of the surface of the cooling roll.

The back surface resin layer of the resin-coated paper of the present invention can be prepared by heating and melting a polyolefin resin mainly on the back surface of a base paper by an extruder, extruding the material between the base paper and cooling roll in a film state, adhering by pressure and cooling. At this time, the cooling roll is used for formation of a surface shape of the coating layer made of the polyolefin resin. The surface of the resin layer can be subjected to embossing treatment such as slightly rough surface, or patterned surface such as silk state or matte state, etc. depending on the shape of the surface of the cooling roll.

In the present invention, by making a relation represented by (B+C)/A 0.15 to 0.45, where A is a thickness of the base paper as a support, B is a thickness of the front surface resin layer of the resin-coated paper and C is a thickness of the back surface resin layer of the resin-coated paper, a possibility of causing flaw or uneven glossiness can be reduced on the surface of the ink-receptive layer when it is stored in a rolled state. When (B+C)/A is larger than 0.45, a thickness of the base paper becomes relatively thinner while the resin layers become thicker, lowering a cushioning property of the base paper, and the thickened resin layers with a poor cushioning property synergistically lowers cushioning property of the support as a whole, and this is expected to increase a chance of causing flaw when preserved in a rolled state. The lower limit of (B+C)/A is 0.15. If it is lower than 0.15, the resin layers become thin, whereby lowering glossiness and smoothness of the surface of the ink-receptive layer. Preferred range of (B+C)/A is 0.20 to 0.40.

A method of providing a resin-coated layer on the front surface or the back surface of paper may include, in addition to the method in which a resin is melted under heating, extruded and coated on paper, a method in which an electron radiation curing resin is coated on paper and an electron beam is irradiated to the resin to form a cured film, a method in which a coating liquid containing a polyolefin resin emulsion is coated on paper, and after drying, a surface smoothening treatment is carried out, and the like. In either of the cases, a resin-coated paper which can be applied to the present invention can be obtained by carrying out an embossing treatment with a heat roll having an unevenness, etc.

In the present invention, a thickness and a density of the base paper are values obtained from a method defined in JIS-P8118. A thickness of the thermoplastic resin layer can be obtained from an observation of a section of the resin-coated paper by an electron microscope.

In the present invention, at the surface of the resin-coated paper on which an ink-receptive layer is provided by coating, a subbing layer may be further provided under the ink-receptive layer. The subbing layer can be previously provided on the resin layer surface of the support by coating and drying before the ink-receptive layer is provided by coating. The subbing layer preferably comprises a film-formable water-soluble polymer or polymer latex, etc. as a main component. The subbing layer more preferably comprises a water-soluble polymer such as gelatin, polyvinyl alcohol, polyvinyl pyrrolidone, water-soluble cellulose, etc., particularly preferably gelatin. An amount to be attached of the water-soluble polymer to the surface of the resin layer is preferably about 10 to about 500 mg/m², more preferably about 20 to about 300 mg/m². Moreover, the subbing layer may further contain a surfactant, a film hardening agent, etc. Furthermore, before coating the subbing layer, the resin-coated paper is preferably subjected to a corona discharge treatment.

In the polyolefin resin-coated paper support according to the present invention, also included is a material in which various kinds of back-coating layer is/are provided for writability, antistatic property, curl preventive property, etc., within the range which does not lower the effects of the present invention. The back-coating layer preferably comprises a binder as a main component and an amount to be coated is preferably about 100 to about 500 mg/m² in terms of a solid content. To the back-coating layer, a hydrophilic binder, a latex, an organic pigment, an inorganic pigment, an inorganic antistatic agent, an organic antistatic agent, a curing agent, a surfactant, etc., may be added with an optional combination.

In the present invention, as the inorganic fine particles to be contained in the ink-receptive layer, there may be mentioned inorganic fine particles such as light calcium carbonate, heavy calcium carbonate, magnesium carbonate, kaolin, titanium dioxide, zinc oxide, zinc hydroxide, calcium silicate, magnesium silicate, synthetic silica, alumina, hydrated alumina, aluminum hydroxide, magnesium hydroxide, etc.

In view of high printing density, clear image and inexpensive manufacturing cost, synthetic silica, alumina and hydrated alumina are preferred and fumed silica is particularly preferred.

The inorganic fine particles to be contained in the ink-receptive layer of the present invention is contained preferably 50% by weight or more, more preferably 60% by weight or more, further preferably 70% by weight based on the total solid content of the ink-receptive layer. If it exceeds 90% by weight, strength of the ink-receptive layer is lowered which results in frequent cracks, and a problem of scattering powder in the preparation step or processing step arises and flaws tend to be caused when a printed product is handled. If it is contained less than 50% by weight, the ink-absorption property is lowered.

In synthetic silica, there are two types of materials, one (precipitated silica) of which is prepared by the wet process and the other (fumed silica) is prepared by the gas phase process. Usual silica fine particles mean those prepared by the wet process in many cases. As the silica prepared by the wet process, there are (1) a silica sol obtained by metathesis of sodium silicate by an acid or passing through an ion exchange resin layer; (2) a colloidal silica obtained by heating and maturing the silica sol of (1); (3) a silica gel obtained by gelling silica sol in which formation conditions thereof are changed whereby primary particles of a silica gel having a diameter of several μm to 10 μm are siloxane-bonded to form three-dimensional secondary particles; and (4) a synthetic silicic acid compound mainly comprising silicic acid obtained by heating silica sol, sodium silicate, sodium aluminate, etc.

Fumed silica to be preferably used in the present invention is also called to as the drying method silica opposed to the wet method silica, and the fumed silica can be generally prepared by a flame hydrolysis method. More specifically, it has been known a method in which silicon tetrachloride is burned with hydrogen and oxygen. In this method, silanes such as methyl trichlorosilane, trichlorosilane, etc., may be used alone in place of silicon tetrachloride or in combination with silicon tetrachloride. The fumed silica is commercially available from Nippon Aerosil K.K. (Japan) under the trade name of Aerosil, and K.K. Tokuyama (Japan) under the trade name of QS type, etc.

In the present invention, it is preferred to use fumed silica having an average primary particle size of about 5 to 50 nm, and to obtain higher glossiness, it is more preferably 5 to 20 nm and has a specific surface area measured by the BET (Brunauer-Emmett-Teller) method of about 100 to about 400 m²/g. The BET method herein mentioned means one of a method for measuring surface area of a powder material by a gas phase adsorption method and is a method of obtaining a total surface area possessed by 1 g of a sample, i.e., a specific surface area, from an adsorption isotherm. In general, as an adsorption gas, a nitrogen gas has been used in many cases, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A specific surface area can be obtained by measuring an adsorption amount based on the BET equation and multiplying the amount with a surface area occupied by the surface of one adsorbed molecule.

When the fumed silica is used, a recording material having good ink absorption property and high glossiness can be obtained, however, there is a defect that aggregation property of secondary particles is weak and the surface is easily flawed which is supposedly caused by less number of silanol groups on the surface of the silica particles. Due to this defect, flaws are frequently caused when the recording material is kept in a rolled state at the time of production or processing. This problem can be solved by the present invention.

In the present invention, an amount of the inorganic fine particles to be contained in the ink-receptive layer is preferably in the range of about 10 to about 35 g/m², more preferably in the range of about 13 to about 30 g/m². If the content of the inorganic fine particles exceeds the above range, surface cracks tend to be caused, while if it is less than the above range, ink-absorption property becomes poor.

The ink-receptive layer of the present invention preferably contains a binder to maintain the characteristic as a film, and a hydrophilic binder which has high transparency and gives high permeability of ink is preferably used. For using the hydrophilic binder, it is important that the hydrophilic binder does not clog voids by swelling at an initial stage of permeating ink. In this point of view, a hydrophilic binder having a relatively low swellability at around a room temperature is preferably used. Particularly preferred hydrophilic binder is a completely or partially saponified polyvinyl alcohol or a cation-modified polyvinyl alcohol. For dispersing the fumed silica, a dispersing machine conventionally known such as a high-pressure homogenizer, ball mill, etc. may be used.

Among the polyvinyl alcohol, particularly preferred is a partially or completely saponified polyvinyl alcohol having a saponification degree of 80% or more. It is also preferred that the polyvinyl alcohol has an average polymerization degree of about 500 to about 5000.

Also, as the cation-modified polyvinyl alcohol, there may be mentioned a polyvinyl alcohol having a primary to tertiary amino group or a quaternary ammonium group at the main chain or the side chain thereof as disclosed in, for example, Japanese Provisional Patent Publication No. 10483/1986.

Also, a binder other than hydrophilic binder may be used in combination, but an amount thereof is preferably 20% by weight or less based on the amount of the hydrophilic binder. An amount of the hydrophilic binder to be used is preferably 35% by weight or less, based on the ink-receptive layer in view of the ink-absorption property. It is more preferably in the range of 10 to 25% by weight. However, flaws of the ink-receptive layer by abrasion, etc. are frequently caused due to an elastic movement of the recording material while it is kept in a rolled state, where an application of the present invention is required.

In the present invention, the ink-receptive layer preferably contains an amphoteric surfactant. As the amphoteric surfactant, there are mentioned carboxyammonium betaine type, sulfoammonium betaine type, amino acid type, ammonium sulfate ester betaine type, imidazolinium betaine type and the like, which are disclosed in the U.S. Pat. No. 3,843,368, Japanese Provisional Patent Publications No. 49535/1984, No. 236546/1988, No. 303205/1993, No. 262742/1996, No. 282619/1998, etc. Specific examples thereof are shown below.

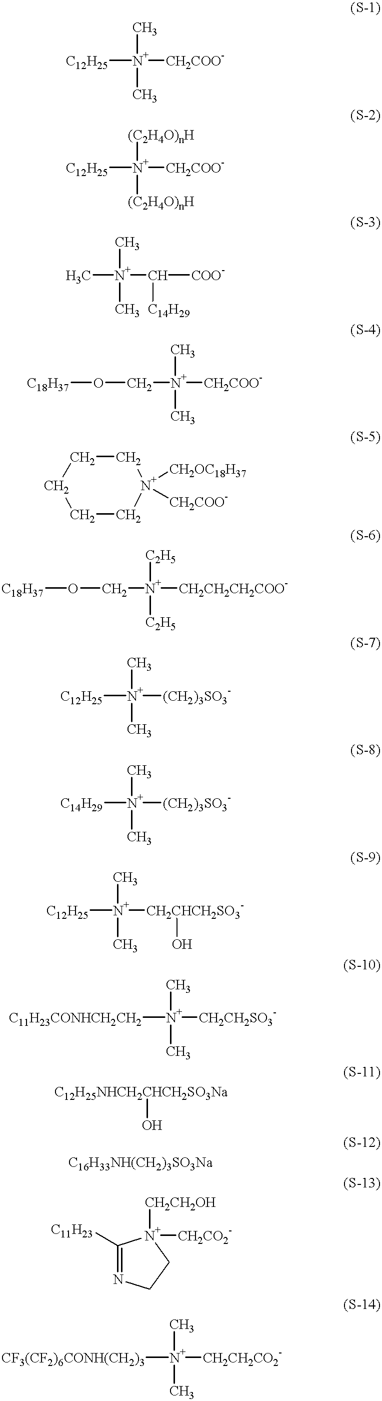

The reason is not yet clear, however, it is figured out that by adding an amphoteric surfactant to the ink-receptive layer, a flaw due to abrasion and uneven glossiness on the ink-receptive layer can be prevented when it is kept in a rolled state during storage. It is imagined that the amphoteric surfactant gives a proper flexibility to a structure of the inorganic particles in the ink-receptive layer, whereby it reduces an external force such as abrasion due to elastic movement of the recording material when it is kept in a rolled state during storage.

An amount of the amphoteric surfactant is generally 0.05 to 10% by weight, preferably 0.1 to 5% by weight. When it is less than 0.05%, an effect of preventing flaws due to abrasion during storage in a rolled state is not satisfactory, and when it exceeds 10% by weight, a strength of the ink-receptive layer is lowered causing frequent cracks.

In the present invention, a water-soluble metallic compound is preferably added to the ink-receptive layer so that it is possible to further prevent from causing surface cracks. Accordingly, it is possible to further reduce the amount of the hydrophilic binder and further increase the amount of the inorganic fine particles to improve ink absorption property of the ink-receptive layer.

The water-soluble metallic compound to be used in the present invention may include, for example, as a water-soluble polyvalent metallic salt, a water-soluble salt of a metal selected from the group consisting of calcium, barium, manganese, copper, cobalt, nickel, aluminum, iron, zinc, zirconium, titanium, chromium, magnesium, tungsten, and molybdenum. More specifically, such a water-soluble metallic compound may include, for example, calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, amide nickel sulfate tetrahydrate, aluminum sulfate, aluminum sulfite, aluminum thiosulfate, poly(aluminum chloride), aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, titanium chloride, titanium sulfate, zirconium acetate, zirconium chloride, zirconium oxychloride octahydrate, zirconium hydroxychloride, zirconium nitrate, basic zirconium carbonate, zirconium hydroxide, ammonium zirconium carbonate, potassium zirconium carbonate, zirconium sulfate, zirconium fluoride, chromium acetate, chromium sulfate, magnesium sulfate, magnesium chloride hexahydrate, magnesium citrate nonahydrate, sodium phosphorus wolframate, tungsten sodium citrate, dodecawolframatophosphate n hydrate, dodecawolframatosilicate 26 hydrate, molybdenum chloride, dodecamolybdatephosphate n hydrate, etc.

In the present invention, a cationic polymer is preferably added to improve water resistance. As the cationic polymers to be used in the present invention, there may be preferably mentioned polyethyleneimine, polydiallylamine, polyallylamine, polyalkylamine, as well as polymers having a primary to tertiary amino group or a quaternary ammonium group as disclosed in Japanese Provisional Patent Publications No. 20696/1984, No. 33176/1984, No. 33177/1984, No. 155088/1984, No. 11389/1985, No. 49990/1985, No. 83882/1985, No. 109894/1985, No. 198493/1987, No. 49478/1988, No. 115780/1988, No. 280681/1988, No. 40371/1989, No. 234268/1994, No. 125411/1995 and No. 193776/1998, etc. A number average molecular weight (Mn) of these cationic polymers to be used in the present invention is preferably about 5,000 or more, more preferably about 5,000 to about 100,000.

An amount of these cationic polymers is preferably about 1 to about 10% by weight, more preferably about 2 to about 7% by weight based on the amount of the inorganic fine particles.

In the present invention, various kinds of oil droplets are preferably added to the ink-receptive layer to improve brittleness of a film. As such oil droplets, there may be mentioned a hydrophobic organic solvent having a high boiling point (for example, liquid paraffin, dioctyl phthalate, tricresyl phosphate, silicone oil, etc.) or polymer particles (for example, particles in which at least one of a polymerizable monomer such as styrene, butyl acrylate, divinyl benzene, butyl methacrylate, hydroxyethyl methacrylate, etc. is polymerized) each having a solubility in water at room temperature of 0.01% by weight or less. Such oil droplets can be used in an amount in the range of about 10 to about 50% by weight based on the amount of the hydrophilic binder.

In the present invention, it is preferred to use, in combination with the hydrophilic binder, a cross-linking agent (film hardening agent) of said binder. Specific examples of the cross-linking agent may include an aldehyde type compound such as formaldehyde and glutaraldehyde; a ketone compound such as diacetyl and chloropentanedione; bis(2-chloroethylurea)-2-hydroxy-4,6-dichloro-1,3,5-triazine, a compound having a reactive halogen as disclosed in U.S. Pat. No. 3,288,775; divinylsulfone; a compound having a reactive olefin as disclosed in U.S. Pat. No. 3,635,718; a N-methylol compound as disclosed in U.S. Pat. No. 2,732,316; an isocyanate compound as disclosed in U.S. Pat. No. 3,103,437; an aziridine compound as disclosed in U.S. Pat. No. 3,017,280 and U.S. Pat. No. 2,983,611; a carbodiimide type compound as disclosed in U.S. Pat. No. 3,100,704; an epoxy compound as disclosed in U.S. Pat. No. 3,091,537; a halogen carboxyaldehyde compound such as mucochloric acid, a dioxane derivative such as dihydroxydioxane, an inorganic cross-linking agent such as chromium alum, potassium alum, zirconium sulfate, boric acid and a borate, and they may be used singly or in combination of two or more. Among these, boric acid or a borate is particularly preferred. An amount of the cross-linking agent is preferably about 0.1 to about 40% by weight, more preferably about 0.5 to about 30% by weight based on the hydrophilic binder constituting the ink-receptive layer.

In the present invention, in addition to the amphoteric surfactant and the cross-linking agent, various kinds of conventionally known additives such as a coloring dye, a coloring pigment, a fixing agent of an ink dye, an UV absorber, an antioxidant, a dispersant of the pigment, an antifoaming agent, a leveling agent, an antiseptic agent, a fluorescent brightener, a viscosity stabilizer, a pH controller, etc. may be further added to the ink-receptive layer.

In the present invention, the coating method of the subbing layer, the back-coating layer and the ink-receptive layer is not particularly limited, and a coating method conventionally known in the art may be used. For example, there may be mentioned a slide bead system, a curtain system, an extrusion system, an air knife system, a roll coating system, a rod bar coating system, a bar coater system, a dipping system, etc.

### EXAMPLES

In the following, the present invention is explained in more detail by referring to Examples, but the present invention is not limited by these Examples.

### Example 1

<Production of a Polyolefin Resin-coated Paper Support>

A mixture of a bleached kraft pulp of hardwood (LBKP) and a bleached sulfite pulp of hardwood (NBSP) with a ratio of 1:1 was subjected to beating until it becomes 300 ml by Canadian Standard Freeness to prepare a pulp slurry. To the slurry were added alkyl ketene dimer in an amount of 0.5% by weight based on the amount of the pulp as a sizing agent, polyacrylamide in an amount of 1.0% by weight based on the same as a strengthening additive of paper, cationic starch in an amount of 2.0% by weight based on the same, and polyamide epichlorohydrin resin in an amount of 0.5% by weight based on the same, and the mixture was diluted by water to prepare a 1% slurry. This slurry was made paper by a tourdrinier paper machine to have a basis weight of 100 g/m² and a thickness of 110 μm, dried and subjected to moisture conditioning to prepare a base paper for a polyolefin resin-coated paper. A polyethylene resin composition comprising 100% by weight of a low density polyethylene having a density of 0.918 g/cm³ and 10% by weight of anatase type titanium oxide dispersed uniformly in the resin was melted at 320° C. and the melted resin composition was subjected to extrusion coating on the above-mentioned base paper with a thickness of 16 μm by 200 m/min and subjected to extrusion coating by using a cooling roll subjected to slightly roughening treatment. On the other surface of the base paper, a resin composition comprising 70 parts by weight of a high density polyethylene resin having a density of 0.962 g/cm³ and 30 parts by weight of a low density polyethylene resin having a density of 0.918 g/cm³ was melted at 320° C. and the melted resin composition was subjected to extrusion coating with a thickness of 25 μm and subjected to extrusion coating by using a cooling roll subjected to roughening treatment.

To the front surface of the above-mentioned polyolefin resin-coated paper was subjected to high frequency corona discharge treatment, and then, the following subbing layer composition was coated thereon with a gelatin amount of 50 mg/m² and dried to prepare a support. Incidentally, all “part” in the present specification means “part by weight”.

<Subbing layer composition>

| | |
|---|---|
| Lime-treated gelatin | 100 parts |
| Sulfosuccinic acid-2-ethylhexyl ester salt | 2 parts |
| Chromium alum | 10 parts |

On the above-mentioned support was coated repeatedly an ink-receptive layer coating liquid having the following composition by a slide coating apparatus and dried. The ink-receptive layer coating liquid shown below was so prepared that an amount of the fumed silica became 9% by weight in terms of a solid concentration. This coating liquid was coated on the above-mentioned support so that a coated amount of the fumed silica became 25 g/m² in terms of a solid content and dried.

<Ink-receptive layer coating liquid>

| | |
|---|---|
| Furled silica | 100 parts |
| (Average primary particle size: 7 nm, Specific surface area | |
| by the BET method: 300 m²/g) | |
| Dimethyldiallyl ammonium chloride homopolymer | 4 parts |
| (Shallol DC902P, trade name, available from Daiichi | |
| Kogyo Seiyaku K.K., Japan, molecular weight (Mn): 9000) | |
| Boric acid | 3 parts |
| Polyvinyl alcohol | 20 parts |
| (Saponification degree: 88%, Average polymerization | |
| degree: 3,500) | |

Flaw resistance of the ink-receptive layer during storage, an ink-absorption property and glossiness of the ink-receptive layer of the thus prepared recording material were evaluated by the following methods. The results are shown in Table 2.

<Flaw Resistance of Ink-receptive Layer>

Each of the ink-jet recording materials with a width of 335 mm obtained from Examples 1 to 5 and Comparative Examples 1 and 2 was used to prepare a roll of the recording material with a length of 30 m (using a 3 inch paper core), by applying 50 kg of tensile force, and it was fixed by an adhesive tape. They were subjected to heat treatment under the conditions of 40° C. and 0% RH (relative humidity) for 4 days and a portion of the ink-receptive layer of the recording material at 1 m from an inner terminal side of the roll was directly observed with eyes. Evaluations were made according to the following standards.

∘: No flaw of the ink-receptive layer was observed.

Δ: Suitable for a practical use with slightly noticeable flaws on the ink-receptive layer.

×: Not suitable for a practical use due to remarkable flaws on the ink-receptive layer.

In cases of the ink-jet recording materials obtained in Examples 6 to 10, they were all at the level of ∘ in the above evaluations. Therefore, tests were conducted in the same manner as the above except that the tensile force applied to prepare rolls was changed to 80 kg as well as for Example 1, and evaluations were made according to the following standards.

∘: No flaw on the ink-receptive layer was observed.

Δ: Flaws were slightly noticeable on the ink-receptive layer.

×: Flaws on the ink-receptive layer were remarkable.

<Ink Absorption Property>

Each of the ink-jet recording materials obtained from Examples 1 to 10, and Comparative Examples 1 and 2 was subjected to black solid printing by using an ink-jet printer MJ-5100C (trade name, available from Seiko Epson K.K., Japan) under the conditions of 20° C. and 65% RH. After 30 seconds, a PPC paper was overlapped over the printed portion with a slight pressurization, and the degree of an amount of the ink transferred to the back surface of the PPC paper was directly observed with eyes and evaluated according to the following standards.

∘: No transfer to the back surface was observed.

Δ: Partial transfer to the back surface was observed.

×: Apparent transfer to the back surface was observed.

<Glossiness of Ink-receptive Layer>

Each of the recording materials for ink-jet recording prepared in Examples 1 to 10 and Comparative examples 1 and 2 before printing were observed with eyes and evaluated according to the following standards.

∘: Extremely good as close to printing paper for photography.

Δ: Good at the level of art paper or coated paper.

×: Extremely poor almost at the level of matte paper.

### Examples 2 to 5

Each of the ink-jet recording materials of Examples 2 to 5 was obtained in the same manner as in Example except for changing a basis weight and a thickness of the base paper and thickness of the polyethylene resin on the both surfaces as shown in Table 1. They were evaluated in the same manner as in Example 1. The results are shown in Table 2.

### Examples 6 to 10

In the same manner as in Example 1 except for adding 0.3 part of a surfactant (S-1), (S-4), (S-7) and (S-11), respectively as shown in Table 1 based on 100 parts of the fumed silica to the ink-receptive layer coating liquid, each of the ink-jet recording materials of Examples 6 to 9 was prepared and evaluated in the same manner as in Example 1. The results are shown in Table 3.

### Example 10

In the same manner as in Example 1 except for replacing the surfactant (S-1) with polyoxyethylene (9) laurylether, an ink-jet recording material of Example 10 was prepared. Its evaluation results are shown in Table 3.

### Comparative Example 1

In the same manner as in Example 1 except for changing thickness of the polyethylene resin on the both surfaces shown in Table 1, an ink-jet recording material of Comparative example 1 was obtained and evaluated in the same manner as in Example 1. The results are shown in Table 2.

### Comparative Example 2

In the same manner as in Example 1 except for changing a basis weight of the base paper to 120 g/m² and a density of the base paper to 1.09 g/cm³, an ink-jet recording material of Comparative Example 2 was obtained. Its evaluation results are shown in Table 2.

TABLE 1

| | Thickness | | Thickness | | |
|---|---|---|---|---|---|
| | of base | Density | of resin | | |
| | paper | of base | layers | | |
| | (A) | paper | (B/C) | (B + C)/A | Surfactant |
| Example 1 | 110 | 0.91 | 16/25 | 0.37 | None |
| Example 2 | 96 | 1.04 | 16/25 | 0.43 | None |
| Example 3 | 160 | 0.63 | 16/25 | 0.26 | None |
| Example 4 | 110 | 0.91 | 24/24 | 0.44 | None |
| Example 5 | 110 | 0.91 | 7/10 | 0.15 | None |
| Example 6 | 110 | 0.91 | 16/25 | 0.37 | S-1 |
| Example 7 | 110 | 0.91 | 16/25 | 0.37 | S-4 |
| Example 8 | 110 | 0.91 | 16/25 | 0.37 | S-7 |
| Example 9 | 110 | 0.91 | 16/25 | 0.37 | S-11 |
| Example 10 | 110 | 0.91 | 16/25 | 0.37 | nonionic |
| Comparative | 110 | 0.91 | 27/27 | 0.49 | None |
| example 1 | | | | | |
| Comparative | 110 | 1.09 | 16/25 | 0.37 | None |
| example 2 | | | | | |

Units in the table are μm for thickness and g/cm³ for density.

Abbreviations for surfactants in the table represent those surfactants shown above.

TABLE 2

| | Flaw resistance | | |
|---|---|---|---|
| | daring storage | Ink- | Glossiness of |
| | (tensile force | absorption | Ink-receptive |
| | 50 kg) | property | layer |
| Example 1 | ◯ | ◯ | ◯ |
| Example 2 | Δ | ◯ | ◯ |
| Example 3 | ◯ | ◯ | Δ |
| Example 4 | Δ | ◯ | ◯ |
| Example 5 | ◯ | ◯ | Δ |
| Comparative | X | ◯ | ◯ |
| example 1 | | | |
| Comparative | X | ◯ | Δ |
| example 2 | | | |

TABLE 3

| | Flaw resistance | | |
|---|---|---|---|
| | during storage | Ink- | Glossiness of |
| | (tensile force | absorption | Ink-receptive |
| | 80 kg) | property | layer |
| Example 1 | Δ | ◯ | ◯ |
| Example 6 | ◯ | ◯ | ◯ |
| Example 7 | ◯ | ◯ | ◯ |
| Example 8 | ◯ | ◯ | ◯ |
| Example 9 | ◯ | ◯ | ◯ |
| Example 10 | Δ | ◯ | ◯ |

It can be concluded that the ink-jet recording materials of Examples 1 to 10 of the present invention were excellent in ink-absorption property and glossiness with a low chance of flaws on the ink-receptive layer when they were kept in a rolled state at the time of production and processing.

Flaw resistances of the ink-receptive layer were lowered in Example 2 where the density of the base paper was high and in Example 4 where a thickness ratio of the front surface resin to the back surface resin (B/C) was 1 and a thickness ratio of the sum of resin layers of the front and back surfaces relative to the base paper ((B+C)/A) was 0.44, which was slightly high. However, there were at a level of a practical use. Glossiness of the ink-receptive layer were slightly lowered in Example 3 where the density of the base paper is low and in Example 5 where the thickness of the front surface resin layer is thin, but they are all at a level of a practical use.

Examples 6 to 10 were the cases where an amphoteric or nonionic surfactants were added to the ink-receptive layer of Example 1, and it was shown that ink-absorption property, surface glossiness and flaw resistance during storage were excellent. For those Examples, the flaw resistance during storage was tested under more sever conditions, where the recording materials containing the amphoteric surfactants showed excellent flaw resistances, while the recording material of Example 10 containing the nonionic surfactant showed slightly lowered resistance as in the case of Example 1.

Comparative Example 1 is a case where a thickness ratio of the sum of the resin layers of the front and back surfaces relative to the base paper ((B+C)/A) is 0.49, and it showed lowered flaw resistance of the ink-receptive layer during storage, not satisfying a level of a practical use. Comparative Example 2 is a case where the density of the base paper was changed to 1.09 in Example 1, and it showed a largely lowered flaw resistance during storage as well as a slightly lowered surface glossiness probably due to a high density of the base paper, thereby failing to satisfy a level of a practical use.

According to the present invention, there can be obtained an ink-jet recording material which is excellent in flaw resistance of the ink-receptive layer when it is stored in a rolled state, and shows good ink-absorption property and glossiness.

1. An ink-jet printing material comprising a support in which both surfaces of a base paper are covered by a polyolefin resin, and an ink-receptive layer containing inorganic fine particles and a hydrophilic binder provided on the support, wherein the ink-jet recording material satisfies a relation of {(B+C)/A}=0.15 to 0.45, where A is a thickness of the base paper; B is a thickness of the polyolefin resin layer at the surface on which the ink-receptive layer is provided; and C is a thickness of the polyolefin resin layer at the opposite surface to that on which the ink-receptive layer is provided, a density of the base paper is 0.60 to 1.05 g/cm³, A is 50 to 300 μm, and B is 5 to 25 μm.

2. The ink-jet recording material according to claim 1, wherein B is 8 μm or more and less than 20 μm.

3. The ink-jet recording material according to claim 1, wherein a ratio of B/C is less than 1.

4. The ink-jet recording material according to claim 3, wherein B is 8 μm or more and less than 20 μm.

5. The ink-jet recording material according to claim 1, wherein the ink-receptive layer contains the inorganic fine particles in an amount of 50 to 90% by weight.

6. The ink-jet recording material according to claim 1, wherein the inorganic fine particles are fumed silica which has an average primary particle size of 5 nm to 50 nm.

7. The ink-jet recording material according to claim 1, wherein the ink-receptive layer contains an amphoteric surfactant.

8. The ink-jet recording material according to claim 7, wherein the ink-receptive layer contains the amphoteric surfactant in an amount of 0.1 to 5% by weight.

9. The ink-jet recording material according to claim 1, wherein the ink-receptive layer contains the hydrophilic binder in an amount of 10 to 25% by weight.
